(19) United States
(12) Patent Application Publication
(10) Pub. No.: US 2017/0058932 A1
(43) Pub. Date: Mar. 2, 2017

(54) Expansion Anchor

(71) Applicant: Robert COUSINEAU, Ottawa (CA)

(72) Inventor: Robert COUSINEAU, Ottawa (CA)

(21) Appl. No.: 15/123,382

(22) PCT Filed: Mar. 6, 2015
(86) PCT No.: PCT/CA2015/050171

§ 371 Date: Sep. 2, 2016

Related U.S. Application Data
(60) Provisional application No. 61/949,993, filed on Mar. 7, 2014.

(51) Int. Cl. F16B 13/06; F16B 13/00; F16M 13/02

(52) U.S. Cl. CPC F16B 13/065; F16M 13/027; F16B 13/003; F16B 2013/007

(57) ABSTRACT

An expansion anchor is provided, which is generally comprised of a drill rod, cone tip and anchor to create an undercut. In one embodiment, the drill rod is connected to the setting tool while in another embodiment, the cone tip is connected to the setting tool. In both instances, rotation of one or the other engenders a corresponding rotation from the anchor, which forces the cone tip upwards and into the anchor, which thus forces the anchor outwards and sets the expansion anchor. A sectional coloured threading is also provided to allow an operator to determine when the anchor is sufficiently set.

### FIELD OF THE INVENTION

The invention relates to anchors and, more specifically, to an anchor with a carbide bit on a lamellae.

### BACKGROUND

Anchors are conventionally used in construction to attach various components of a building construction to an overhead ceiling or other structure. Such components to be attached can relate to, for example, services that provide plumbing, electrical, drainage, sprinkler system piping and drop ceilings. From these anchors, which are usually of the sleeve type or wedge type variety, all of the above services and ceilings are suspended or secured.

Conventionally, in setting anchors in concrete to suspend an awning, for example, a hole is pre-drilled in the surface to which the anchor is to be applied, and then the anchor is inserted into the pre-drilled hole. However, when setting such anchors in concrete it is not uncommon for such anchors to weaken and loosen over time, particularly in situations where cracking or chipping of the concrete around the pre-drilled hole has occurred.

Furthermore, studies have revealed that cracking can typically occur in the concrete element, and that such cracks can significantly impact the performance of anchors. Cracks can originate on a concrete beam or slab in a variety of ways, such as creep, temperature settlement of the support or foundation, thermal expansion and contraction stress overload, or from a natural disaster such as an earthquake or flood. In such situations, the situation can arise where, if one such concrete anchor fails and lets go, the remaining anchors, by virtue of the weight they additionally assume in light of such failure, can also similarly collapse and fail.

It has been found that enlarging the lower (interior) part of the pre-drilled hole can allow for the use of anchors in a more secure manner. It has further been found that providing a pre-drilled hole with an enlarged, conical lower end can be advantageously provided by an expansion anchor having an anchor with spreading lamellae, including a carbide bit on at least one of the lamellae, whereby tightening of a nut and washer, which are flush with the bore hole, would cause the cone tip to move back, upwards relative to the bottom of the hole, and into the anchor to spread the lamellae.

It would be advantageous to have either the cone be directly connected to a setting tool, such that it can be tightened and pulled upwards and into the anchor, or it could be also advantageous to provide a locking means between the anchor and a drill rod, and the resulting force of pulling the drill rod back and upwards would disengage such a connection, and pull the cone tip upwards as well.

### SUMMARY OF THE INVENTION

In a first aspect, the present invention provides an expansion anchor for creating an undercut in cementuous materials, comprising a cone tip to receive a setting tool at a first end and having a key at a second end; an anchor with a carbide bit to create the undercut, positioned over the cone tip and comprised of a slit to receive the key of the cone tip; and, a drill rod positioned over the cone tip to restrict the anchor from upward movement; wherein the continued rotation of the cone tip secures the anchor within the undercut.

In a second aspect, the present invention provides an expansion anchor for creating an undercut in cementuous materials comprising a drill rod to receive a setting tool at a first end and having a locking opening at a second end; an anchor with a carbide bit to create the undercut comprising a locking protrusion for engaging the locking opening of the drill rod; and, a cone tip in threaded engagement with the drill rod to operatively engage the anchor and secure the anchor within the undercut, wherein the continued rotation of the drill rod secures the anchor within the undercut.

### BRIEF DESCRIPTION OF THE DRAWINGS

The following figures serve to illustrate various embodiments of features of the invention. These figures are illustrative and are not intended to be limiting.

FIG. 1 is a front perspective view illustrative of an expansion anchor with spreading lamellae having a carbide bit according to a first embodiment of the present invention;

FIG. 2 is a perspective exploded view illustrative of an expansion anchor with spreading lamellae having a carbide bit engaged with a drill rod according to a second embodiment of the present invention;

FIG. 2a is a perspective view illustrative of an anchor with spreading lamellae having a carbide bit according to a second embodiment of the present invention;

FIG. 3a is a perspective exploded view illustrative of an expansion anchor with an anchor in locking engagement with a drill rod according to a third embodiment of the present invention.

FIG. 3b is a partially cut away view illustrative of an expansion anchor when it is set, with the cone tip fully inserted within the anchor according to a third embodiment of the present invention.

FIG. 4a is a perspective exploded view illustrative of an expansion anchor with a cone tip being inserted into a drill rod and locked into an anchor according to a fourth embodiment of the present invention.

FIG. 4b is a partially cut away view illustrative of an expansion anchor when it is set, with the cone tip fully inserted within the anchor according to a fourth embodiment of the present invention.

### DETAILED DESCRIPTION

The following embodiments are merely illustrative and are not intended to be limiting. It will be appreciated that various modifications and/or alterations to the embodiments described herein may be made without departing from the invention and any modifications and/or alterations are within the scope of the contemplated invention.

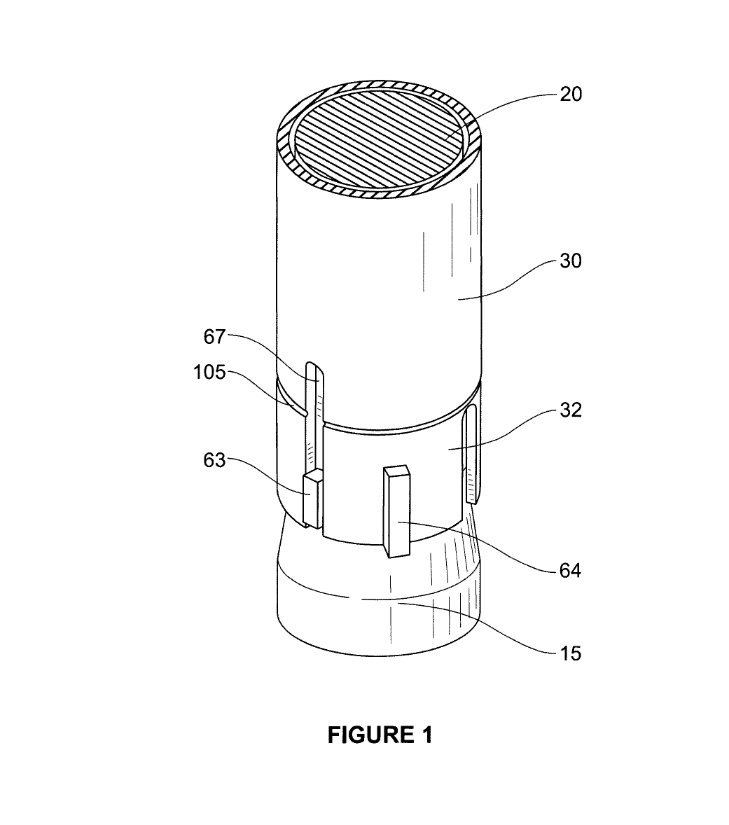

With reference to FIG. 1 and according to a first embodiment of the present invention, a hollow anchor 30 is shown surrounding a drill rod 20 in a position at rest on a cone tip 15. The drill rod 20 is utilized in conjunction with a standard setting tool (not shown), drill connector (not shown) and impact drill (not shown), all of which are well-known in the art and provide for the necessary force and drive to create a bore hole and an undercut in cemetuous materials such as concrete and as described in U.S. Provisional Patent Nos. 61/839,274 and 61/846,933. In this particular embodiment, the drill rod 20 is in threaded engagement with the cone tip 15 and a worker skilled in the art would appreciate that the connection between the drill rod 20 and the cone tip 15 could be of another type such as machined together, or other similar means. The anchor 30 is further comprised of spreading lamellae 32, which are separated from said anchor 30 by means of an annular recessed area 105. The purpose of the spreading lamellae 32 is to spread out over the cone tip 15 when creating an undercut and setting the anchor 30. The spreading lamellae 32 will spread outwards from the annular recessed area 105. A key 63 is also shown, located on the drill rod 20 whose purpose is to properly position the anchor 20 by aligning said key 63 in between two adjacent spreading lamellae 32 and in slit 67. By providing such a positioning, the anchor 30 is forced to turn in the same direction as the drill rod 20 which is forced into the bore hole. In order to create the undercut, a carbide bit 64 is machined or brazed onto any of the spreading lamellae 32. It is well-understood that the carbide bit 64 must extend outwardly beyond the circumference of both the bore hole and the cone tip 15; otherwise, the carbide bit 64 will not be able to create an undercut. In operation, the carbide bit 64 will rotate along with the anchor 30 and spreading lamellae 32 by virtue of the key 63, and create the undercut while the anchor 30 is forced downward by virtue of an impact drill (not shown) exerting force onto a setting tool portion (not shown), and a bore hole sleeve (not shown). A worker skilled in the relevant art would be familiar that one or more carbide bits could be positioned on the spreading lamellae.

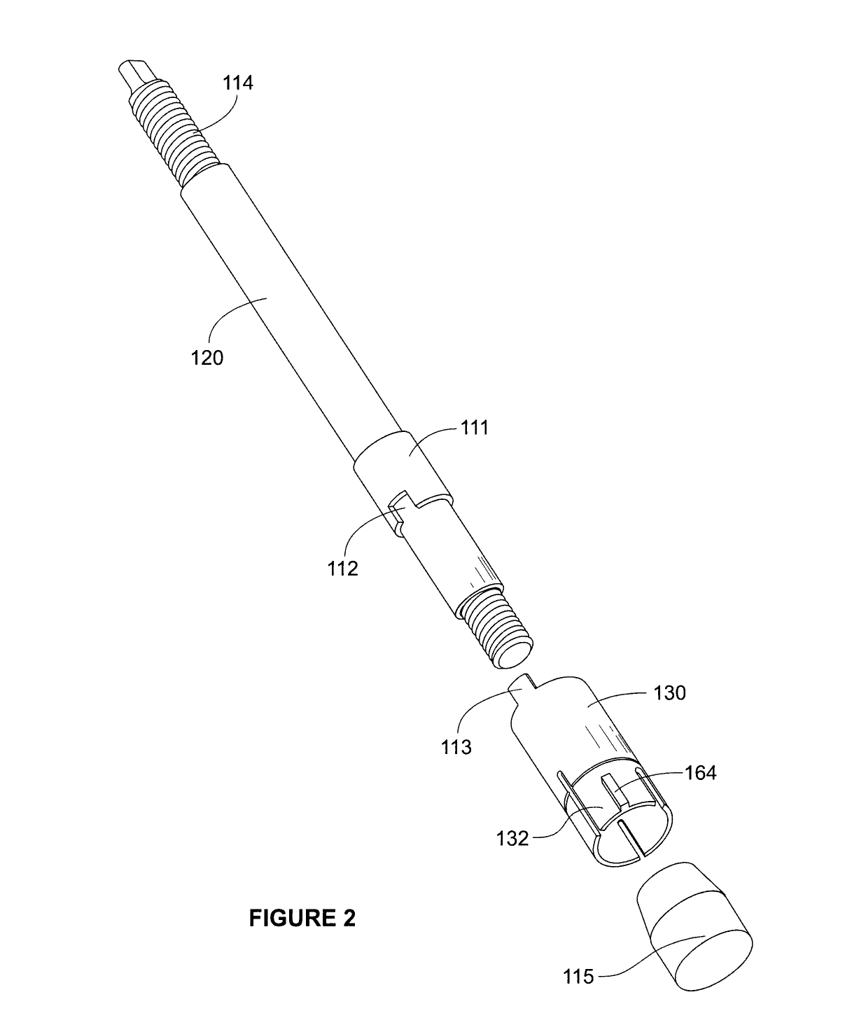

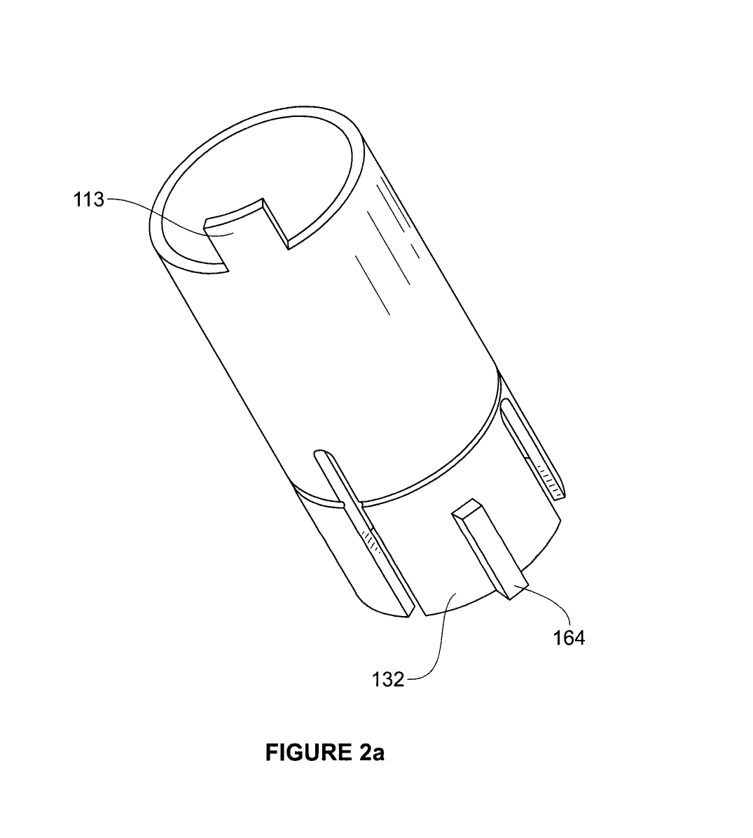

With reference to FIGS. 2 and 2a and according to a second embodiment of the present invention, a modified drill rod 120 is shown further comprised of an annular locking member 111. The annular locking member 111 is comprised of a locking opening 112, which is designed for operative engagement with a locking protrusion 113 of an anchor 130. Indeed, in lieu of having the locking operation performed by means of a slit and key as was the case in the first embodiment, the second embodiment locks the anchor 130 into the drill rod 120 by means of engaging the locking protrusion 113 of the anchor 130 with the locking opening 112 of the annular locking member 111 of the drill rod 120. As was the case in the first embodiment, the anchor 130 is further comprised of a carbide bit 164 which is machined or brazed onto any of the spreading lamellae 132. In order to create the undercut in the bore hole, the drill rod 120, in threaded engagement with the cone tip 115, and the anchor 130 are drilled into said bore hole by means of an impact drill (not shown). Once the bore hole has been created, a nut (not shown) and washer (not shown) which are flush with the upper surface of the cementuous material, are rotated clockwise so as to reverse the direction of the drill rod 120 and cone tip 115 up and out of the bore hole. In doing so, the carbide bit 164, which is generally wider than the circumference of the bore hole and cone tip 115 that was created by virtue of the impact drill (not shown), will act as an anchoring point, keeping the anchor 130 in place, and rotate to begin creating the undercut by forcing the lamellae 132 outwardly around the cone tip 115. Meanwhile, the cone tip 115 is being forced back upwards, thus forcing the spreading lamellae 132 to spread outwards and around said cone tip 115. As the spreading lamellae 132 are forced outwards due to the receding of the cone tip 115, the carbide tip 164 which is located on one of the spreading lamellae 132, creates a wider and wider undercut. In order to determine when to stop the reverse drilling process, the threaded upper portion 114 of the drill rod 120 can be painted a certain colour. In operation, as the reverse drilling occurs, said colour will eventually protrude from the nut (not shown) and be visible to indicate that the undercut is complete. A worker skilled in the relevant art would be familiar that one or more carbide bits could be positioned on the spreading lamellae under this second embodiment. A worker skilled in the relevant art would further appreciate that in this second embodiment, the bore hole sleeve (not shown) which would normally force the anchor 130 downwards is not needed; the configuration of the annular locking member 111 and locking protrusion 113 achieve this; thus reducing the amount of parts (and money) necessary.

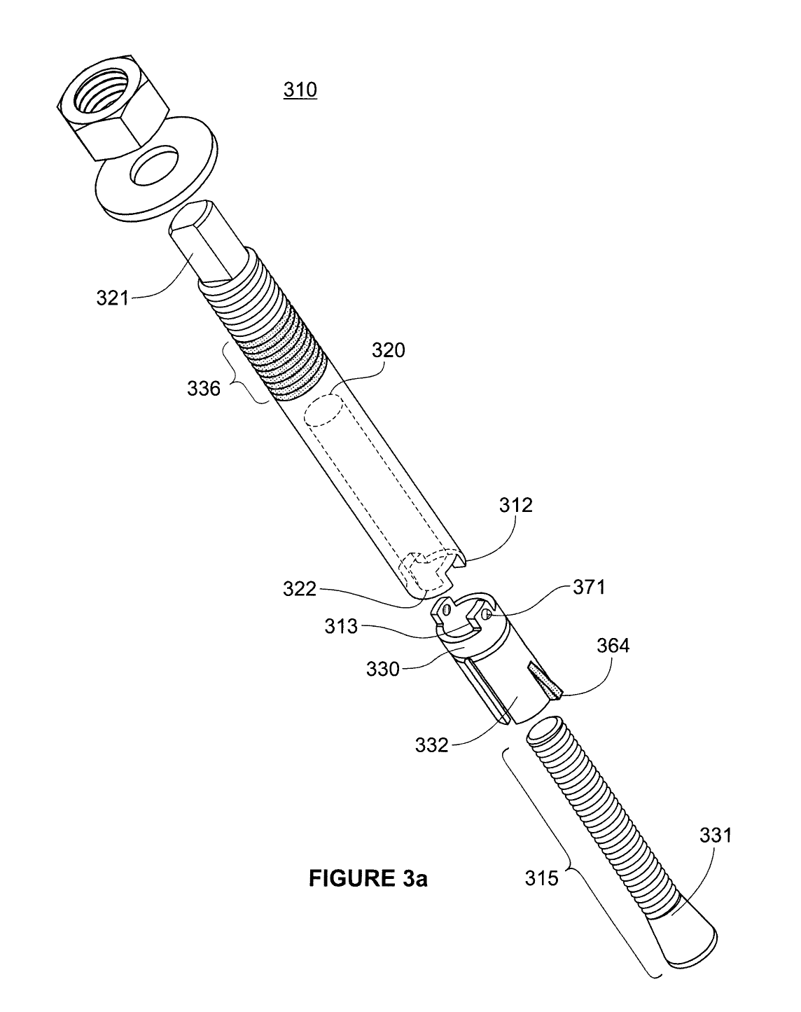

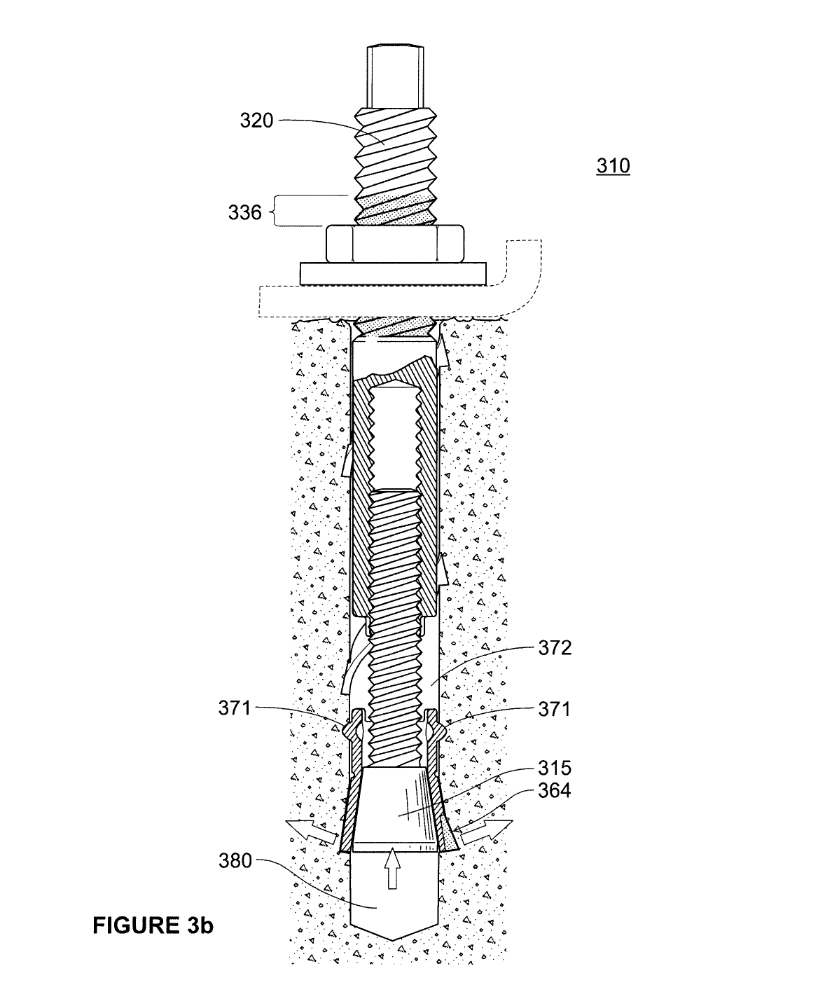

With reference to FIGS. 3a and 3b and according to a third embodiment of the present invention, an expansion anchor 310 is shown for creating an undercut in cementuous materials, generally comprised of a drill rod 320 to receive a setting tool (not shown), an anchor 330 with a carbide bit 364 to create the undercut, and a cone tip 315 in threaded engagement with the drill rod 320 and to be positioned over and inserted into the anchor 330. The drill rod 320 has a first and second end 321, 322, the first end 321 able to receive a setting tool (not shown) for drilling the expansion anchor 310, and the second end 322 having a locking opening 312. The anchor 330 is also comprised of a locking protrusion 313 for engaging the locking opening 312 of the drill rod 320 such that the drilling of the drill rod 320 engages the anchor 330 and enables the anchor 330 to rotate in the same direction. Once the anchor 330 and drill rod 320 are locked one into the other, the cone tip 315 is threaded into the drill rod 320 until the anchor 330 is able to sit on an upper edge 331 of said cone tip 315. The nut and washer fastened onto the drill rod 320, along with the anchor 330 sitting on the cone tip 315 are inserted into the pre-drilled bore hole 380. Once the cone tip 315 has reached the bottom of the pre-drilled bore hole 380, the setting tool (not shown) is removed and a device known in the art such as a socket wrench is used to fasten the nut, which is now flush with the entrance of the bore hole 380. Continued fastening of the nut will engender a corresponding upwards movement from the drill rod 320 and cone tip 315, the latter of which is threaded onto the former, as is specifically shown in FIG. 3b. The carbide bit 364 of the anchor 330 and a nub 371 located on the locking protrusion 313 together act as anchoring points and prevent the anchor 330 from rotating along with the drill rod 320, such that the continued rotation of the nut disengages the connection between the locking protrusion 313 and locking opening 312, thereby creating a gap 372. While the nub 371 is specifically positioned on the locking protrusion 313, a worker skilled in the art could position said nub on another position on the upper end of the anchor 330 without departing from the scope of the invention. As the cone tip 315 is forced upwards, it will operatively engage the anchor 330 such that the spreading lamellae 332 will spread outward, over the cone tip 315 thus anchoring the expansion anchor 310. A worker skilled in the art would appreciate that while there are two spreading lamellae 332 in the present invention, more lamellae are possible without departing from the scope of the device. As the carbide bit 364 is located on one lamellae 332, said carbide bit 364 will eat away at the concrete and create the undercut, setting the anchor 330 therein. This spreading of the lamellae 332 is known in the art. The drill rod 320 is further comprised of sectional coloured threading 336, in order to allow an operator of the expansion anchor 310 to stop the continued drilling of the drill rod 320 when a certain portion of the sectional coloured threading 336 is shown. Otherwise, further drilling could destroy the undercut and strip the remainder of the threading on the drill rod 320.

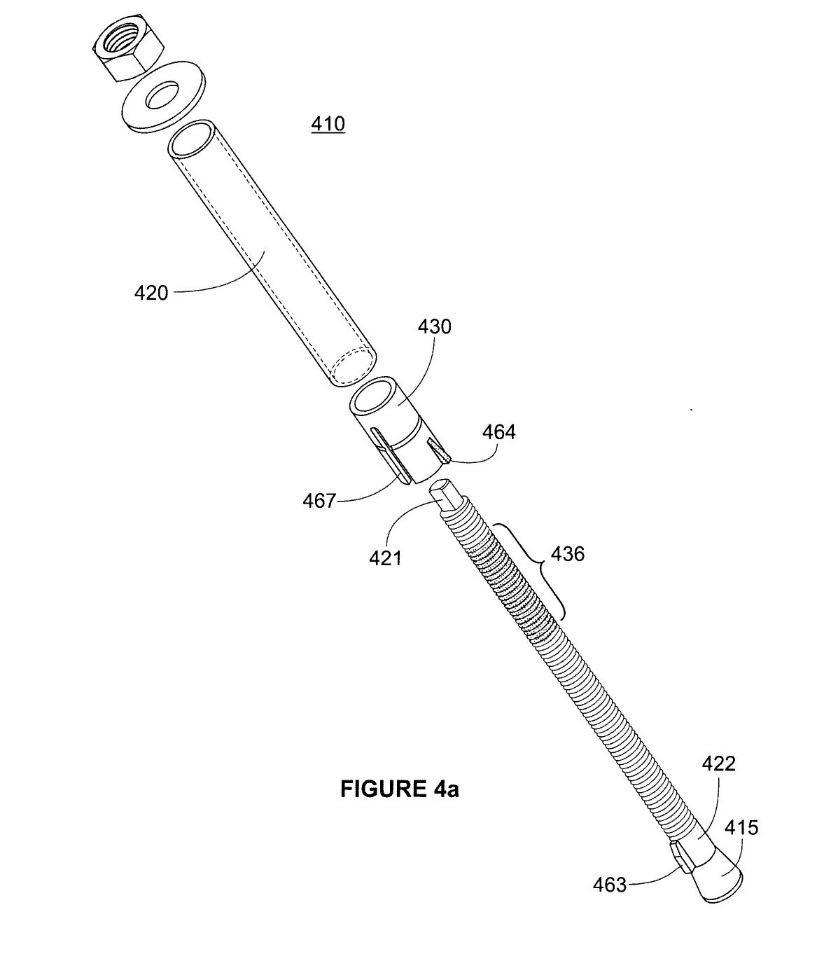

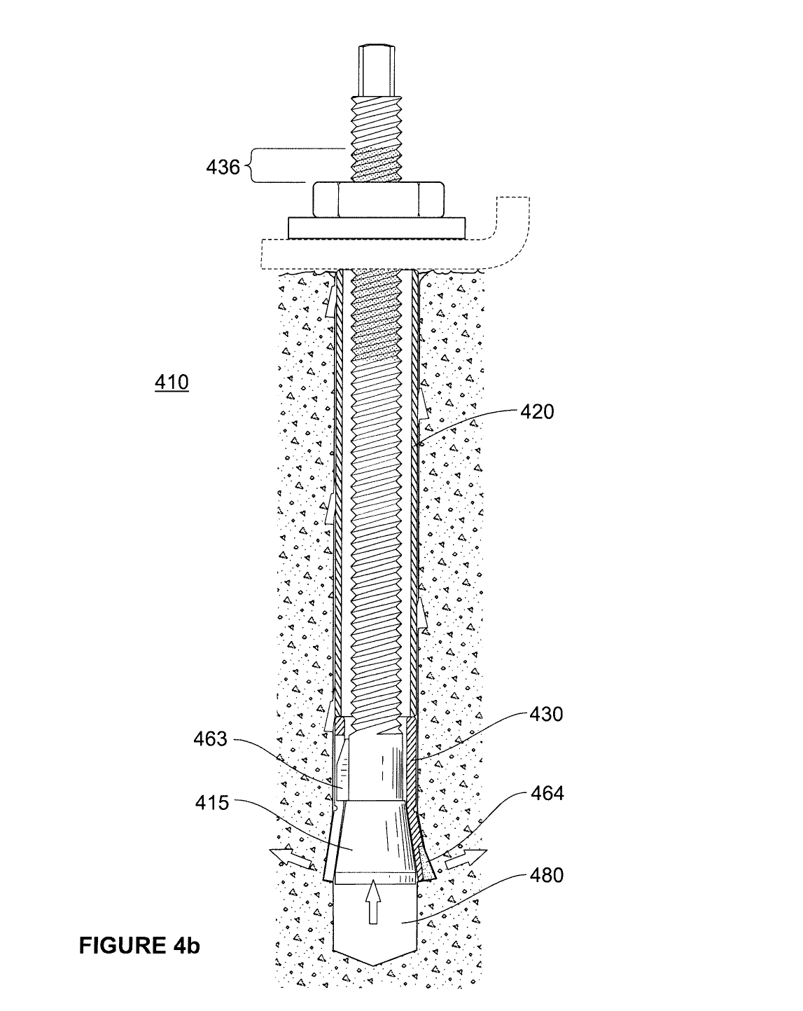

With reference to FIGS. 4a and 4b and according to a fourth embodiment of the present invention, an expansion anchor 410 is shown, generally comprised of a cone tip 415 to receive a setting tool (not shown), an anchor 430 with a carbide bit 464 to create an undercut which will be positioned over the cone tip 415, and a drill rod 420 positioned over the threaded portion of the cone tip 415 to restrict the anchor 430 from any upwards movement. The cone tip 415 can receive the setting tool (not shown) at a first end 421, such that the rotation of the first end 421 by the setting tool (not shown) will rotate the entire cone tip 415. The second end 422 of the cone tip 415 is comprised of a key 463, which serves to engage a slit 467 of the anchor 430, preventing the anchor 430 from any rotation without the corresponding rotation of the cone tip 415. In operation, the drill rod 420, anchor 430 and cone tip 415 are drilled into the pre-existing bore hole 480. Once the cone tip 415 reaches the end of the bore hole 480, a device such as a socket wrench is used to fasten a nut and washer which are threaded over the threaded portion of the cone tip 415 and flush with the opening of the bore hole 480. An operator then continues to rotate the washer, as is specifically shown in FIG. 4b, which forces the cone tip 415 upwards, and forcefully into the anchor 430. The carbide bit 464 of the anchor 430 rotates in the concrete and creates the undercut, while the shape of the second end 422 of the cone tip 415 spreads the lamellae 432 of the anchor 430 outwards. The operator must continue this rotation process until a certain section of the sectional coloured threading 436 is shown, alerting the operator that the anchor 430 is set and that no further rotation of the washer is required; otherwise it could destroy the expansion anchor 410 or strip the threaded portion of the cone tip 415.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated invention which is not to be limited to the specific embodiment disclosed.

What is claimed is:

1. An expansion anchor for creating an undercut in cementuous materials, comprising:
a. a cone tip to receive a setting tool at a first end and having a key at a second end;
b. an anchor with a carbide bit to create the undercut, positioned over the cone tip and comprised of a slit to receive the key of the cone tip; and,
c. a drill rod positioned over the cone tip to restrict the anchor from upward movement;
wherein the continued rotation of the cone tip secures the anchor within the undercut.

2. The expansion anchor of claim 1 wherein the anchor is further comprised of at least two spreading lamellae.

3. The expansion anchor of claim 1 wherein the anchor is further comprised of an annular recessed area.

4. The expansion anchor of claim 1 wherein the cone tip is further comprised of a threaded portion.

5. The expansion anchor of claim 1 wherein the drill rod is further comprised of sectional coloured threading.

6. An expansion anchor for creating an undercut in cementuous materials comprising:
a. a drill rod to receive a setting tool at a first end and having a locking opening at a second end;
b. an anchor with a carbide bit to create the undercut comprising a locking protrusion for engaging the locking opening of the drill rod; and,
c. a cone tip in threaded engagement with the drill rod to operatively engage the anchor and secure the anchor within the undercut,
wherein the continued rotation of the drill rod secures the anchor within the undercut.

7. The expansion anchor of claim 6 wherein the anchor is further comprised of at least two spreading lamellae.

8. The expansion anchor of claim 6 wherein the anchor is further comprised of an annular recessed area.

9. The expansion anchor of claim 6 wherein the cone tip is further comprised of a threaded portion.

10. The expansion anchor of claim 6 wherein the drill rod is further comprised of sectional coloured threading.

11. The expansion anchor of claim 6 wherein the anchor is further comprised of at least one nub.
